(19) United States
(12) Patent Application Publication
(10) Pub. No.: US 2026/0072748 A1
(43) Pub. Date: Mar. 12, 2026

(54) Methods, Apparatuses, Controllers, and Products for Determining the Task Status of Industrial Devices

(71) Applicant: Robert Bosch GmbH, Stuttgart (DE)

(72) Inventors: Wanlin Yang, Shanghai (CN); Shu Wei Goh, Shanghai (CN); Shanya Hu, Shanghai (CN); Ji Zhao, Shanghai (CN); Fan Yang, Shanghai (CN)

(21) Appl. No.: 19/326,057

(22) Filed: Sep. 11, 2025

(30) Foreign Application Priority Data
Sep. 12, 2024 (CN) 2024 1128 0926.0

(51) Int. Cl. G06F 9/50

(52) U.S. Cl. CPC G06F 9/5027

(57) ABSTRACT

Methods, apparatuses, controllers, and products for determining the task status of industrial devices are disclosed. The method includes determining the task completion status of the industrial device, and in response to the industrial device being in the task completed status, acquiring the task log of the industrial device. The task log includes the operational information of the industrial device in the process of executing the assigned task. The method further includes determining the completion condition of the task of the industrial device based on the task log and the set task parameters corresponding to the task assigned to the industrial device. In this way, the completion status of the tasks of the industrial devices can be accurately monitored according to the task logs to ensure that the industrial devices are able to complete the corresponding tasks.

This application claims priority under 35 U.S.C. § 119 to application no. CN 2024 1128 0926.0, filed on Sep. 12, 2024 in China, the disclosure of which is incorporated herein by reference in its entirety.

Embodiments of the present disclosure relate generally to the field of industrial technology and in particular to methods, apparatuses, controllers, and products for determining the task status of industrial devices.

### BACKGROUND

With the rapid growth of technology, the application areas of industrial scenarios are expanding and becoming richer. For example, industrial assembly is a vital link in the manufacturing industry, where various parts are combined in a predetermined order and manner through manual assembly to form a complete product.

As industrial tasks in industrial scenarios become more and more tedious and complex, workers are required to undertake more and more tasks. For example, in the industrial scenario of assembling automotive parts, workers need to undertake a number of tasks, including identification, grabbing, positioning, assembly, and quality testing of parts. Each task requires a high degree of precision and focus to ensure the quality and performance of automotive assembly. Therefore, ensuring the quality of industrial assembly is the key to ensuring the quality of products.

### SUMMARY

Embodiments of the present disclosure provide a method, apparatus, controller, and product for determining the task status of an industrial device.

In a first aspect of the present disclosure, a method for determining the task status of an industrial device is provided. The method comprises determining the task completion status of the industrial device, and in response to determining that the industrial device is in the task completed status, acquiring the task log of the industrial device. The task log includes the operational information of the industrial device in the process of executing the assigned task. The method further comprises determining the completion condition of the task of the industrial device based on the task log and the set task parameters corresponding to the task assigned to the industrial device.

In a second aspect of the present disclosure, an apparatus for determining the task status of an industrial device is provided. The apparatus comprises a completion status determination unit configured to determine the task completion status of the industrial device; and a task log acquisition unit configured to acquire the task log of the industrial device in response to determining that the industrial device is in the task completed status. The task log includes the operational information of the industrial device in the process of executing the assigned task. The completion determination unit is configured to determine the completion condition of the task of the industrial device based on the task log and the set task parameters corresponding to the task assigned to the industrial device.

In a third aspect of the present disclosure, a controller is provided. The controller comprises one or more processors; and a storage device for storing one or more programs, the one or more programs, when executed by the one or more processors, causing the one or more processors to implement a method provided according to the first aspect of the present disclosure.

In a fourth aspect of the present disclosure, a computer-readable storage medium is provided. The computer-readable storage medium has computer-executable instructions stored thereon, wherein the computer-executable instructions are executed by a processor to implement the method provided according to the first aspect of the present disclosure.

According to a fifth aspect of the present disclosure, a computer program product is provided, the computer program product being tangibly stored on a computer-readable medium and comprising computer-executable instructions, the computer-executable instructions, when executed, implementing the method according to the first aspect of the present disclosure.

It shall be understood that the content described in the Summary is not intended to limit key or important features of the examples of the present disclosure, nor is it intended to limit the scope of the present disclosure. Other features of the present disclosure will become readily understood by the following description.

### BRIEF DESCRIPTION OF DRAWINGS

Above and other features, advantages and aspects of various examples of the present disclosure will become more apparent in combination with the accompanying drawings and with reference to the following detailed description. In the accompanying drawings, like or similar accompanying drawings designate like or similar elements, wherein:

FIG. 1 shows a schematic diagram of an exemplary environment in which the device and/or method according to some examples of the present disclosure may be implemented;

FIG. 2 is a schematic diagram showing an interaction process of various execution entities in the process of determining the task status of an industrial device according to some examples of the present disclosure;

FIG. 3 shows a flow chart of a method for determining the task status of an industrial device according to some examples of the present disclosure;

FIG. 4 shows a schematic view of an interactive interface according to some examples of the present disclosure;

FIG. 5 shows a flow chart of a method of a clamping device to determine the task status of an industrial device according to some examples of the present disclosure;

FIG. 6 shows a block diagram of an apparatus for determining the task status of an industrial device according to some examples of the present disclosure; and

FIG. 7 shows a schematic block diagram of an example device according to some examples of the present disclosure.

In all figures, like or similar reference signs represent like or similar elements.

### DETAILED DESCRIPTION

The examples of the present disclosure will be described in further detail below with reference to the accompanying drawings. While certain examples of the present disclosure are shown in the accompanying drawings, it should be understood that the present disclosure may be implemented in various forms and should not be construed as being limited to the examples set forth herein, rather these examples are provided for a more thorough and complete understanding of the present disclosure. It should be understood that the accompanying drawings and examples of the present disclosure are for exemplary purposes only and are not intended to limit the scope of protection of the present disclosure.

In the description of the examples of the present disclosure, the term “comprise” and other similar expressions should be understood as open-ended inclusion, that is, “comprising but not limited to”. The term “based on” should be understood as “at least partially based on.” The term “one example” or “this example” should be understood as “at least one example.” The terms “first,” “second,” etc. may refer to different or the same object. Other explicit and implicit definitions may be included below.

An industrial scenario refers to a scenario that consists of workers, machines, materials, environment, data, etc. for the purpose of industrial production or industrial processing. In an industrial scenario (e.g., an industrial factory environment), a plurality of industrial devices are included. Industrial device is a general term for machines, devices, tools, and facilities used in industrial production processes. It is understood that industrial devices are an important part of achieving an efficient, stable, safe, and environmentally friendly production process.

In this scenario, the workers are the main implementers who operate industrial devices, handle materials, and perform a variety of production tasks. Workers perform tasks that are not only cumbersome, but also require workers to judge whether the parameters used to perform the task are accurate based on the theories at their disposal. For example, workers need to adjust the torque level of power tools during screw tightening according to different needs. That is to say, the current steps or processes of industrial assembly may need to be manually configured by workers. However, manual assembly may present various problems, such as the possibility that workers may not complete various tasks as planned. Failure of users to complete unfinished tasks as scheduled may affect the quality and efficiency of industrial production. For example, workers may miss one or more screws that need to be tightened, causing problems with production quality. Alternatively, workers may use the wrong power tool torque to tighten screws, which may also affect the quality of the assembly.

To this end, embodiments of the present disclosure provide a method for determining the task status of an industrial device. The method comprises determining the task completion status of the industrial device, and in response to determining that the industrial device has completed the task, acquiring the task log of the industrial device. The task log includes the operational information of the industrial device in the process of executing the assigned task. The method further comprises determining the completion condition of the task of the industrial device based on the task log and the task parameters corresponding to the task assigned to the industrial device. In this way, the completion status of the tasks of the industrial devices can be accurately monitored according to the task logs acquired to ensure that the industrial devices are able to complete the corresponding tasks as planned. In addition, the presence of task logs can provide powerful support for quality management, fault analysis, and production optimization in industrial scenarios.

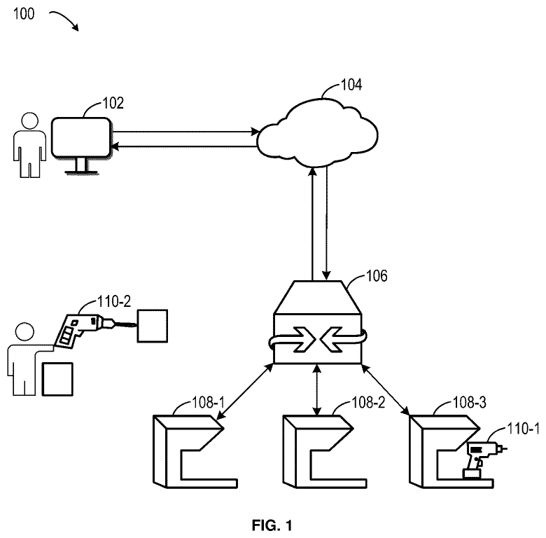

FIG. 1 shows a schematic diagram of an example environment 100 in which a plurality of examples of the present disclosure may be implemented. As shown in FIG. 1, the example environment 100 includes a terminal device 102, a server 104, a gateway 106, a plurality of clamping devices (e.g., clamping device 108-1, clamping device 108-2, clamping device 108-3), and a plurality of industrial devices (e.g., industrial device 110-1, industrial device 110-2). Industrial devices refer to various devices used in industrial production processes, such as welding equipment (welding machines, welding auxiliary devices, etc.), cutting equipment, dispensing equipment, fastening equipment, etc. An industrial device may be configured to perform one or more specific industrial tasks (e.g., drilling, cutting, fastening, sanding, grinding, etc.). An industrial device may be an electric device, such as an electric angle grinder, electric pistol drill, etc. In some examples of the present disclosure, a clamping device may be used to clamp an industrial device on a machine tool or other device to perform various processing operations. For example, the clamping device 108-3 may clamp the industrial device 110-1 on a machine tool or other device.

In the example environment 100, a terminal device 102 is communicatively connected to a server 104, and the server 104 is communicatively connected to a clamping device (e.g., clamping device 108-1, clamping device 108-2, clamping device 108-3) via a gateway 106. The clamping device is communicatively connected to the industrial device. It can be understood that the server 104 can be communicatively connected to a plurality of clamping devices through the gateway 106. For example, the server 104 can be communicatively connected to the clamping device 108-1, the clamping device 108-2, and the clamping device 108-3 through the gateway 106. In other examples of the present disclosure, the example environment 100 may further comprise a plurality of gateways, and the plurality of gateways communicate with the server 104. One gateway is communicatively connected to one clamping device. In some examples of the present disclosure, the communication connection may be a wired connection or a wireless connection. In some examples of the present disclosure, the server 104 may be a backend server. The terminal device 102 has a web portal built in to provide the user with an interface to interact with the system. For example, users can view production data, monitor production processes, adjust set parameters, etc. through the web portal.

In some examples of the present disclosure, the terminal device 102 may provide a user interface and allow the user to access and interact with industrial device information. The user may enter task configuration information (not shown in FIG. 1) through the terminal device 102 to define and configure the industrial assembly or industrial production workflow. For example, the user may configure the industrial device required for a certain step or process and the task parameters corresponding to that industrial device (e.g., working torque, working speed, working time) etc. That is, the user interface of the terminal device 102 can provide the user with an interface to control and customize the task parameters of the industrial device.

In some examples of the present disclosure, after receiving the task configuration information, the terminal device 102 may send the task configuration information to the gateway 106 via an intermediate device such as a server 104. It can be understood that the gateway 106 (e.g., a router) is a device that connects a plurality networks and that the gateway 106 may perform functions such as forwarding data packets, filtering traffic, protocol conversion, address translation, etc. to enable communication between different networks. Upon receiving the task configuration information, the gateway 106 may assign the plurality of tasks contained in the task configuration information to each of a plurality of industrial devices based on the identification information to determine the tasks corresponding to the plurality of industrial devices and the task parameters corresponding to the tasks (not shown in FIG. 1) such that each of the industrial devices completes the assigned tasks according to the task parameters (e.g., one or more industrial devices are responsible for one production step in the order of the production steps).

In some examples of the present disclosure, the gateway 106 may send the task parameters corresponding to each industrial device to the corresponding clamping device. Upon receiving the task parameters, the clamping device may determine whether the identification information indicated by the task parameters matches (e.g., is the same as) the identification information of the industrial device. The industrial device may be activated if the identification information indicated by the task parameters is the same as the identification information of the industrial device. The industrial device is configured according to the received task parameters.

In some examples of the present disclosure, upon activation and configuration of an industrial device, a worker can pick up the industrial device to perform a corresponding task (e.g., cutting a device). It can be understood that in order to be able to monitor the consistency and quality of the production process, the operational information of the industrial device being used can be recorded to generate task logs. For example, a task log for an industrial device may be generated using sensors disposed on the industrial device to collect the operating status and operational information (e.g., number of operations, operating parameters, etc.) of the industrial device. The sensors may include a variety of types for collecting a variety of types of sensor data. For example, the sensors may be a temperature sensor, a pressure sensor, a torque sensor, etc. It can be understood that the data collected by the sensors can reflect the real-time operating status of the industrial device.

In some examples of the present disclosure, a task log of an industrial device refers to the parameters and conditions that are actually used by the industrial device in the performance of a task. For example, task logs may include parameters such as the actual operating time, torque, temperature, pressure, etc. of the device. It can be understood that the task log may be determined based on data collected by the sensors or may be determined based on a recognition result corresponding to an image collected by the monitoring system.

In some examples of the present disclosure, the task configuration information may be sent to various clamping devices via the gateway 106. Upon receiving the task configuration information, the clamping device can determine the task parameters belonging to the industrial device based on the identification information of the corresponding industrial device. That is, the step of determining allocation to the industrial device may be performed at the gateway 106 or at the clamping device. The industrial device can be activated and configured after task parameters are assigned to it. In some examples of the present disclosure, the clamping device, upon receiving the task parameters and the task log, may determine the completion status of a task of the industrial device based on the result of a comparison between the task parameters and the task log.

In this way, the completion status of the tasks of the industrial devices can be accurately monitored according to the task logs acquired to ensure that the industrial devices are able to complete the corresponding tasks with high quality. In addition, the presence of task logs can provide powerful support for quality management, fault analysis, and production optimization in industrial scenarios.

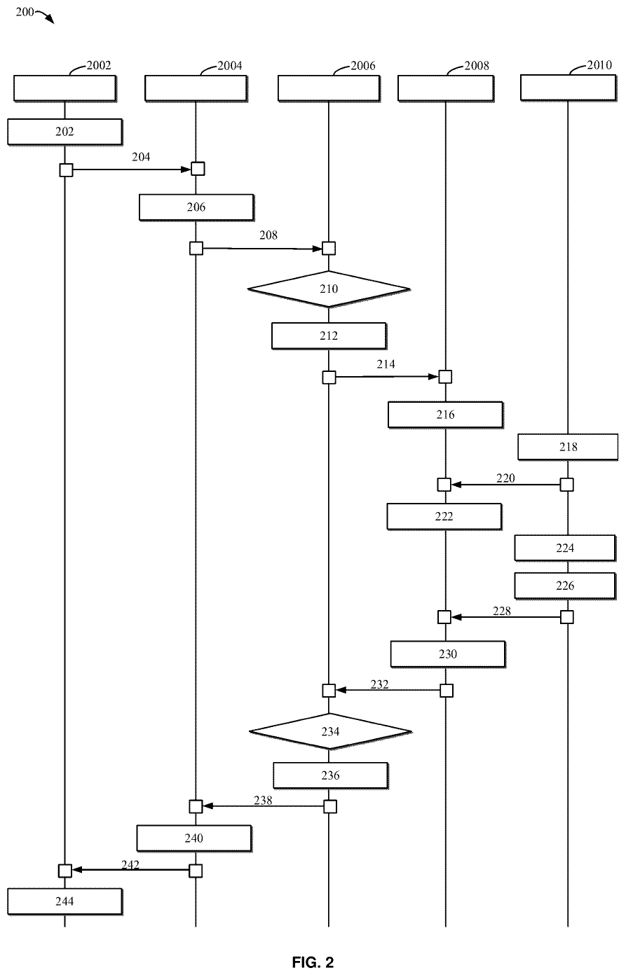

FIG. 2 is a schematic diagram showing an interaction process of various execution entities in the process of determining the task status of an industrial device according to some examples of the present disclosure. As shown in FIG. 2, it comprises a terminal device 2002, a gateway 2004, a clamping device 2006, an industrial device 2008, and a user 2010. It should be understood that the various execution entities involved in the process 200 for determining the task status of industrial devices shown in FIG. 2 are merely examples of the present disclosure and cannot be limitations of the present disclosure. In some examples, more gateways may be included. Referring to FIG. 2, the process 200 of determining the task status of an industrial device may exemplarily include steps 202-244.

In step 202, the user may enter information to set the task configuration information according to actual application needs. The task configuration information includes the task flow required to complete the task as well as the working parameters and the sequence of process steps required to complete the task. For example, the task configuration information may include task parameters for a plurality of industrial devices. It can be understood that the task configuration information may be determined by information entered by a user (e.g., an administrator) on a web portal built into the terminal device 200. In step 204, the terminal device 2002 sends the task configuration information to the gateway 2004.

In step 206, the gateway 2004, upon receiving the task configuration information, may assign the corresponding task and working parameters of the task to the corresponding industrial device 2008. For example, different tasks and parameter sets corresponding to the tasks may be allocated to different industrial devices 2008 according to identification information included in the task configuration information. In step 208, the task parameters corresponding to the industrial device 2008 may be sent to the clamping device 2006 corresponding to the industrial device 2008.

In step 210, the clamping device 2006, upon receiving the corresponding task and task parameters, may verify that the identification information indicated in the task and task parameters is the same as the identification information corresponding to the industrial device 2008. In step 212, when it is verified that the identification information indicated in the task parameters is the same as the identification information corresponding to the industrial device 2008, the industrial device 2008 is activated and configured according to the task parameters so that the industrial device 2008 can be accurately configured and a reference basis can be provided for determining the status of the task. In step 214, task parameters corresponding to the various industrial devices 2008 may be transmitted to the various industrial devices 2008.

In step 216, upon receipt of the activation operation of the clamping device 2006, the industrial device 2008 is activated. After being activated, the industrial device 2008 can be used normally. In step 218, the user 2010 (e.g., a worker in a factory) may pick up the industrial device 2008. During the picking up process, the connection status of the short-range communication between the clamping device 2006 and the industrial device 2008 is the disconnected status. In step 220, based on the disconnected state, information that the industrial device 2008 has been picked up may be sent to the clamping device 2006. At step 222, the clamping device 2006 may determine that the industrial device 2008 has been picked up. When it is determined that the industrial device 2008 has been picked up, the time of disconnection may be determined.

In step 224, the user 2010 may perform an industrial task (e.g., a fastening task (such as tightening screws), a cutting task, etc.) using the industrial device 2008. Upon determining that the industrial task is completed, in step 226, the user 2010 may put the industrial device 2008 back to the clamping device 2006. During the putting back process, the connection status of the short-range communication between the clamping device 2006 and the industrial device 2008 is the reconnected status. In step 228, based on the reconnection status, information indicating that the industrial device 2008 has been put back may be sent to the clamping device 2006. After determining that the clamping device 2006 and the industrial device 2008 are in the reconnected status, the time of reconnection may be determined. At step 230, the clamping device 2006 may determine that the industrial device 2008 has been returned after use. After determining that the industrial device 2008 has reestablished connection with it, the clamping device 2006 may acquire the task log of the industrial device 2008. In some examples, whether the industrial device completes the task (the completion status of the task) may be determined based on the connection status between the clamping device 2006 and the industrial device 2008. In order to distinguish the status of the user 2010 temporarily putting the industrial device 2008 back to the clamping device 2006 (usually resulting in a short-term disconnection and reconnection of the short-range communication) or the status of short-term disconnection caused by network instability from the status in which the task is completed, the status in which the task is completed can be further determined based on the time interval for reconnection. For example, the status of task completion may be determined based on the time interval between the time of reconnection and the time of disconnection. For example, if the reconnection occurs during task execution and the time interval is short (such as within a few seconds or minutes or less than a predetermined time interval), it can be determined that the industrial device 2008 was temporarily put back; if the time interval is long (such as greater than a predetermined time interval), it can be determined that it is a reconnection after the task was completed.

In step 232, the task log may be sent to the clamping device 2006. The task log records the operational information (such as torque, working time, speed, etc.) of the user 2010 when using the industrial device 2008 to perform the industrial task. Since the task parameters assigned to the industrial device 2008 include the industrial task that needs to be completed by the industrial device 2008 (e.g., tightening 20 screws), if the industrial task is not completed (e.g., only 15 screws are tightened), the completion quality of the industrial task will be affected. Accordingly, in step 234, the clamping device 2006 may determine whether the industrial device 2008 is qualified to complete the industrial task based on the task log. In step 236, it can be determined that the industrial device 2008 has completed the task. In step 238, the working condition of the industrial device 2008 may be fed back to the gateway 2004. It can be understood that if the industrial device 2008 fails to complete the task satisfactorily, the industrial device 2008 is reactivated and an abnormal notification is returned to inform the user 2010. The user 2010 then uses the industrial device 2008 to complete the rest of the industrial task.

In steps 240-244, after receiving the working condition of the industrial device 2008 (step 240), the gateway 2004 can send the working condition to the terminal device 2002 (step 242), and the terminal device 2002 shall update the completion condition or completion status of the industrial task according to the working condition (step 244) so that the user may monitor the industrial progress and optimize the production process according to the completion status. The gateway 2004 has data processing and forwarding capabilities and can format or aggregate the received data and then send it to the terminal device 2002.

In this way, a semi-automated production method can be provided for the industrial production process, allowing the completion status of industrial tasks to be monitored in real time. This not only enables proper configuration and efficient use of industrial devices, but also ensures industrial tasks can be carried out accurately and smoothly, resulting in increased production efficiency and product quality.

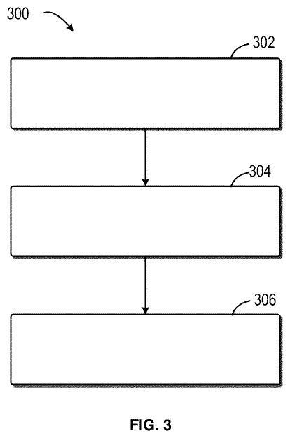

FIG. 3 shows a flow chart of a method 300 for determining the task status of an industrial device according to some examples of the present disclosure. In some examples, the method 300 may be performed by a clamping device (e.g., clamping device 108-1, clamping device 108-2, clamping device 108-3) or an industrial device (e.g., industrial device 110-1, industrial device 110-2) shown in FIG. 1, by a gateway 106 shown in FIG. 1, or by a server 104. It should be understood that the method 300 may also comprise additional actions not shown and/or actions that may be omitted as shown, the scope of the present disclosure being not limited in this regard. In FIG. 3, the method 300 may include steps 302 to 306. The method 300 shown in FIG. 3 is exemplarily described below by taking the execution entity as a clamping device.

At block 302, the task completion status of the industrial device is determined. Industrial devices (e.g., the industrial device 110-1 shown in FIG. 1 or the industrial device 2008 shown in FIG. 2) refer to devices that accomplish one or more industrial tasks in an industrial scenario. Industrial tasks may include a variety of types, such as cutting tasks, fastening tasks, grinding tasks, etc. Depending on the type of industrial task, industrial devices may also include a variety of types, such as cutting devices, fastening devices, grinding devices, etc. The task completion status of the industrial device may be determined according to instructions entered by a user or based on a recognition result of an image containing the industrial device. For example, a user performing a task with the industrial device may inform the clamping device or other device of the task completion status of the industrial device by performing a specific operation (e.g., clicking a specific button or entering a voice command etc.).

At block 304, in response to determining that the industrial device is in the task completed status, the task log of the industrial device acquired, where the task log includes the operational information of the industrial device in the process of performing the assigned task. The task log records the operational statistics of industrial tasks (e.g., the number of operations, operation time), identification information of industrial devices, maintenance information of industrial devices, etc. For example, the task log may include the startup time, shutdown time, and working time of the industrial device, and may also include the specific tasks performed by the industrial device and the parameters used to complete the task (e.g., speed, temperature, pressure, etc.). In some examples of the present disclosure, whether the industrial device is in the task completed status may be determined by using a monitoring system or based on a completion instruction sent by a user.

At block 306, the completion condition of the task of the industrial device is determined based on the task log and the task parameters corresponding to the task assigned to the industrial device and the task log. In some examples of the present disclosure, the completion of an industrial task requires a plurality of processes or steps. Industrial tasks can be divided into a plurality of sub-tasks according to steps or processes. Different industrial devices can be responsible for different sub-tasks. On this basis, the sub-tasks assigned to industrial devices can be determined based on the industrial tasks. That is, the sub-task is performed by the industrial device; e.g., the sub-task can be performed according to set working parameters. Task parameters refer to the working hours, speed, pressure, torque, etc. of the industrial device.

It can be understood that after monitoring that the industrial device has completed the task, the completion condition (including completion quality) of the industrial device can be tested. In some examples of the present disclosure, the completion status of a task may include completed or not completed, and the completion condition of a task may include qualified completion of the task or unqualified completion of the task. Qualified completion of the task means that the industrial device has completed the expected task and the actual execution parameters and execution result meet the requirements (e.g., the industrial device completes the corresponding task as planned). Incomplete means that the industrial device has completed part of the task, while some of the task has not been completed due to omissions or other reasons. Unqualified completion of a task may occur when industrial device completes certain tasks according to incorrect execution parameters or when incorrect parameters or methods are used during the execution of the task, resulting in the execution result not meeting the requirements. In some examples, unqualified completion of a task may be due to a mismatch between the task steps actually performed by the industrial device and the scheduled task steps or a mismatch between the number of parts actually used by the industrial device and the scheduled number of parts to be used. For example, if a screw is tightened according to an incorrect torque, the degree of tightening of the screw does not meet the usage requirements. In some examples of the present disclosure, the completion status of the task may be determined based on the result of a comparison between the task parameters and the task log.

In this way, the task completion status of the industrial devices can be effectively determined according to the task logs acquired to ensure that the industrial devices are able to complete the corresponding tasks with high quality. In addition, the presence of task logs can provide powerful support for quality management, fault analysis, and production optimization in industrial scenarios.

In some examples of the present disclosure, the actual execution parameters (e.g., the speed, torque, etc. acquired from the task log) used by the industrial device in performing the task may be compared to the preset task parameters. Based on the comparison results, the completion condition of the task of the industrial device can be determined. For example, if the two match or are within the actually acceptable error range, it can be determined that the industrial device has completed the task (the task has been completed satisfactorily); if the difference between the two is not within the acceptable error range, it can be determined that the industrial device has not completed the task or the industrial device has not completed the task satisfactorily. For example, when the torque actually used by the industrial device is 100 Nm but the torque indicated in the task parameters is 50 Nm, it is determined that the task of the industrial device has not been completed satisfactorily. Alternatively, where the actual effective number of tightening times of the industrial device is 10 and the effective number of tightening times indicated in the task parameters is 6, it is determined that the industrial device has not completed the task.

In some examples of the present disclosure, the completion condition of the task of the industrial device may also be determined based on the result of a comparison between the operational information contained in the task log and the task parameters. For example, it is possible to determine whether the industrial device has performed the task according to the completion time and execution steps indicated in the task parameters based on the actual execution steps and completion time of the industrial device during the performance of the task. If the judgment is yes, it can be determined that the completion condition of the task of the industrial device is qualified completion.

In some examples of the present disclosure, after determining that the completion condition of the task of the industrial device is that the task has not been completed, which tasks are included in the unfinished tasks of the industrial device can be determined based on the task log. For example, in one example, when the task parameter of the industrial device is to tighten 15 screws using a torque of 50 Nm, if the industrial device only tightens 13 screws using a torque of 50 Nm during the task, it can be determined that the unfinished task of the industrial device is that the remaining 2 screws have not been tightened. In some example of the present disclosure, when it is determined that the completion condition of a task of the industrial device is that the task has not been completed, an abnormal notification may be returned to remind the user that the task has not been completed. To assist the user in efficiently completing the remaining tasks, the user may also be sent the unfinished tasks so that the user can quickly identify the unfinished tasks.

In some examples of the present disclosure, the communication connection between an industrial device (e.g., the industrial device 110-1 shown in FIG. 1) and a clamping device (e.g., the clamping device 108-3 shown in FIG. 1) may be a short-range communication connection. For example, the industrial device and the clamping device can communicate through short-range connection methods such as high-fidelity wireless communication (Wi-Fi) connection, near-field communication (NFC) connection, Bluetooth connection, wireless local area network (WLAN) connection, and infrared communication (IRC) connection. In some examples of the present disclosure, the connection between the industrial device and the clamping device may be an NFC connection in order to save costs.

In some examples of the present disclosure, short-range communication generally has an effective distance (e.g., 10 meters, 20 meters, etc.). When a certain effective distance is exceeded, the short-range communication between the clamping device and the industrial device will be disconnected, so whether the industrial device has completed the task can be determined based on the communication status of the short-range communication. For example, when the communication status of the short-range communication between the industrial device and the corresponding clamping device is disconnected, it can be determined that the industrial device is being used to complete its set work content (such as tightening screws); when the communication status of the short-range communication between the industrial device and the clamping device is reconnected, it can be determined that the industrial device is in the task completed status or it can be determined that the industrial device is in the temporarily put back status.

In some implementations, when the communication status between the clamping device and the industrial device is in the disconnected status, the time when the communication is disconnected may be determined. When the communication status between the clamping device and the industrial device is in the reconnected status, the time of reconnection may be determined. Whether the industrial device is in the task completed status is determined based on the time interval between the time when the communication is disconnected and the time when the communication is reconnected. If the time interval is greater than the predetermined time interval, it can be determined that the industrial device is in the task completed status. If the time interval is less than the predetermined time interval, it indicates that the industrial device is not in the task completed status.

It must be noted that industrial device A being in the task completed status here means that the user (e.g., a factory worker) believes that the set work content has been completed using industrial device A. In other examples of the present disclosure, determining whether the industrial device is in the task completed status may also be achieved through a status indication of the device itself or a timer within the system.

In this way, it is possible to directly and accurately determine whether the industrial device has completed the task based on the communication connection status between the clamping device and the industrial device, thereby providing accurate triggering conditions for determining the completion status of subsequent tasks of the industrial device.

In some examples of the present disclosure, since industrial tasks may change due to product replacement or order changes, in order to successfully complete the changed industrial tasks, the user is required to input corresponding task configuration information so that each industrial device can clearly identify the tasks to be completed. On this basis, a user may be provided with an interactive interface for interaction using a terminal device (e.g., the terminal device 102 shown in FIG. 1). The interactive interface may include a command interface, a menu interface, a graphical user interface, etc. The terminal device can be directly connected to the industrial device for communication, or it can be indirectly connected to the industrial device through a clamping device.

It can be understood that after acquiring the task log of the industrial device and the completion status of the task, the industrial device or the clamping device can send the task log or completion status to the terminal device, where it will be displayed on the interactive interface of the terminal device so that the user can understand the operating status and production efficiency of the industrial device more intuitively and clearly. In other examples of the present disclosure, the ultimately determined completion status of the task of the industrial device and the unfinished tasks can also be sent to the terminal device and displayed on the interactive interface of the terminal device so that the user (such as an administrator) can intuitively and clearly determine whether the corresponding tasks have been completed as planned.

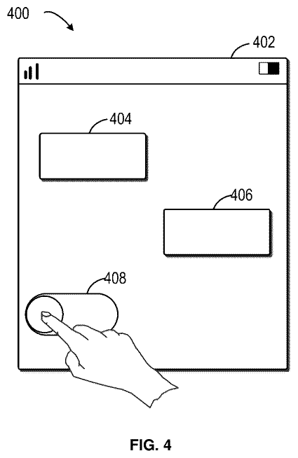

FIG. 4 shows a schematic view of an interactive interface according to some examples of the present disclosure. As shown in FIG. 4, the interactive interface 402 (e.g., an interactive interface of a terminal device) may include an input block 404, a display component 406, and a determination control 408. The user may enter task configuration information (not shown in the figure) in input block 404 to define the objectives and parameters of the tasks of the various industrial devices according to actual needs. After entering the task configuration information, the user may trigger the determination control 408. The determination control 408 can be triggered by a trigger event to run and complete the corresponding function.

The trigger event may include a mouse click, a tap by the user's finger, etc. The determination control 408 may be in the form of a button control, which may include a text box button, a pure icon button, etc. In some examples of the present disclosure, a display component 406 may be used to display information of a plurality industrial devices (e.g., the name of the industrial device, the completion status of the task, the power level, etc.).

In some examples of the present disclosure, the task configuration information may include a plurality of tasks, each of which is a sub-task, which may be performed by different industrial devices. The different sub-tasks comprise a set of a plurality of task parameters. It can be understood that there may be various types of task parameters, such as torque, pressure, temperature, time, etc. By assigning different sub-tasks to different industrial devices, the tasks and task parameters corresponding to the different industrial devices can be determined. For example, in one example, the task configuration information includes task A, task B, and task C. Task A includes task parameter set A, task B includes task parameter set B, and task C includes task parameter set C. Task A is executed by industrial device A, task B is executed by industrial device B, and task C is executed by industrial device C. The set of task parameters assigned to industrial device A is set A, and all task parameters in set A are task parameters of industrial device A.

In some examples of the present disclosure, a task or set of task parameters may indicate identification information corresponding to an industrial device. For example, the identification information may be the version number, model number, etc. of the industrial device. Based on the identification information, a plurality of tasks or a plurality of task parameter sets can be respectively assigned to corresponding industrial devices, thereby determining the tasks and task parameters corresponding to the industrial devices. In this way, industrial tasks can be reasonably assigned such that each industrial device performs the task as assigned and provides an accurate basis for determining the completion status of the tasks of industrial devices.

In some examples of the present disclosure, task logs may be collected by sensors corresponding to industrial devices. The sensors may be disposed on the industrial device to acquire the execution parameters of the industrial device. To ensure that the task log contains a wealth of information, the number and types of sensors can be a plurality. For example, the sensors may be a temperature sensor, a pressure sensor, a torque sensor, etc. In some examples of the present disclosure, a timer may also be disposed on the industrial device. The timer determines the startup time, shutdown time, etc. of the industrial device. The data collected by sensors can be used to determine the execution parameters and device status used by industrial device in the process of performing tasks, thereby determining the task log of the industrial device.

In other examples of the present disclosure, the task log may also be determined by information input by the user. For example, a user may record usage conditions, such as adopted parameters or the status of the industrial device, while using the industrial device to perform industrial tasks. Based on the record information entered by the user, the task log corresponding to the industrial device can be determined. In this way, task logs containing a wealth of information can be generated based on a variety of data to provide a comprehensive picture of the working condition of an industrial device and to help users judge whether tasks have been missed or performed incorrectly.

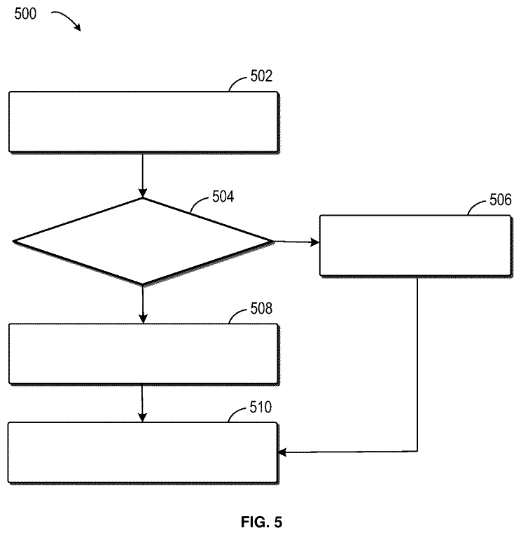

FIG. 5 shows a flow chart of a method of a clamping device to determine the task status of an industrial device according to some examples of the present disclosure. As shown in FIG. 5, the clamping device, upon receiving a task log sent by the industrial device, may determine whether all of the processes of the task assigned to the industrial device have been completed before determining the completion status of the task of the industrial device.

In step 502, the clamping device may read a task log. Task logs are collected by sensors corresponding to the industrial device and sent by the industrial device to the clamping device. In step 504, the clamping device may judge whether the industrial device has completed the required task according to the task log; i.e., whether the industrial device has performed all the set processes. In step 506, if it is determined that the industrial device has not completed the required tasks, the industrial device may be reactivated so that the industrial device completes the remaining industrial tasks again. In step 508, the completion status of the task of the industrial device is determined to be complete according to the task log. In step 510, after it is finally determined that the industrial device has completed all set tasks, the completion status of the tasks of the industrial device may be updated.

In this way, it is possible to judge whether the industrial device has completed the corresponding tasks based on the task log, thereby preventing the industrial device from missing certain tasks and improving the completeness and accuracy of task completion.

In some examples of the present disclosure, a user may perform a task using different parameters based on their experience in the process of using an industrial device to perform a task. For example, when tightening a screw, the user may use a torque of 50 Nm for the tightening effect. If the execution parameters actually adopted by the user are different from the set task parameters, it can be determined whether the task parameters need to be reconfigured based on the working status of the industrial device. The working status of the industrial device may be a specific status (such as power consumption, vibration, operating temperature, etc.) or condition of the working device when performing a task. Whether the working status meets the preset requirements can be determined based on preset standards or thresholds. The standards or thresholds can be set based on the performance specifications of the device, safety requirements, and the specific needs of the task. For example, when the operating efficiency or stability of the industrial device reaches the performance indicators, it can be determined that the working status meets the preset requirements. In other examples, the need to reconfigure the task parameters may also be determined based on the status of a component targeted by the industrial device when the task is executed. The status of the component may be determined according to whether the component is functioning well. For example, if the component has no faults or abnormalities and key indicators are within normal ranges, then it can be considered that the working status meets the requirements.

In one example, the task parameter assigned to the industrial device is 60 Nm, which is different from the actual torque 50 Nm used by the user. If the tightening effect of the screw is better using a torque of 50 Nm, the torque involved in the task parameters can be changed to 50 Nm. For example, if it is determined based on sensor data collected by sensors installed on products or parts targeted by the industrial device that a torque of 50 Nm is sufficient to provide sufficient tightening force without causing material damage or that screws tightened at a torque of 50 Nm are less loose after long-term use or experiencing specific vibrations, the torque involved in the task parameters can be changed to 50 Nm. In other examples, a user (e.g., a tester) may also determine if the tightening effect is better based on the test results. In this way, users can monitor the consistency and quality of the production process and optimize the production process by adjusting and optimizing task parameters as necessary based on actual performance.

In some examples of the present disclosure, when the communication status of the short-range communication between the clamping device and the industrial device is the reconnection status, the actual torque of the industrial device can be acquired based on the short-range communication connection. If the actual torque is different from the torque indicated in the task parameters and the actual torque works better, the torque of the industrial device can be calibrated using a clamping device to ensure that it meets the process requirements. In this way, it can be ensured that industrial device has the correct torque setting the next time it is used, improving production consistency and quality.

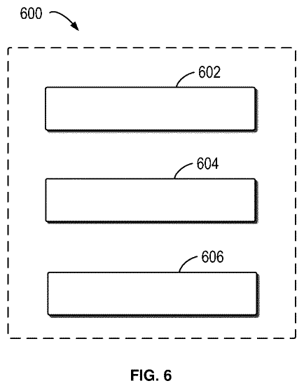

FIG. 6 shows a block diagram of an apparatus 600 for determining the task status of an industrial device in some examples of the present disclosure. Referring to FIG. 6, the apparatus 600 comprises a completion status determination unit 602 configured to determine the task completion status of the industrial device; and a task log acquisition unit 604 configured to acquire the task log of the industrial device in response to determining that the industrial device is in the task completed status. The task log includes the operational information of the industrial device in the process of executing the assigned task. The completion determination unit 606 is configured to determine the completion condition of the task of the industrial device based on the task log and the set task parameters and task log corresponding to the task assigned to the industrial device.

In some examples, the communication mode between the industrial device and the clamping device corresponding to the industrial device is short-range communication, and the completion status determination unit 602 is further configured to: determine the completion status of a task of an industrial device based on the communication status of the short-range communication.

In some examples, the completion status determination unit 602 is further configured to: in response to the communication status of the short-range communication being the disconnected status, determine that the industrial device is in the task incomplete status; and in response to the communication status of the short-range communication being the reconnected status, determine that the industrial device is in the task completed status based on the number of reconnections and the time interval between reconnections.

In some examples, the clamping device is communicatively connected to the terminal device via a gateway, and the apparatus further comprises a task parameter determination unit configured to: determine task configuration information by the terminal device based on information entered by a user, wherein the task configuration information comprises a plurality of tasks and a plurality of corresponding task parameters; and determine task parameters corresponding to the tasks assigned to the industrial device by assigning a plurality of tasks to a plurality of industrial devices based on the identification information of the industrial devices.

In some examples, each of the plurality of tasks has configuration identification information, and the task parameter determination unit is further configured to: determine the task assigned to the industrial device and the corresponding task parameter set based on the matching result between the identification information of the industrial device and the configuration identification information of each task.

In some examples, the apparatus 600 further comprises an activation unit configured to: activate and configure the industrial device based on matching the configuration identification information with the identification information of the industrial device.

In some examples, the completion condition determination unit 606 is further configured to: determine that the task completion condition of the industrial device is unqualified and return an abnormal notification when the set task parameters do not match the actual task parameters included in the task log.

In some examples, the apparatus 600 further comprises an adjustment unit configured to: When it is determined that the task completion condition of the industrial device is unqualified, the working status of the industrial device is acquired; and when the working status meets the preset requirements, the set task parameters of the industrial device are adjusted based on the actual working parameters.

In some examples, the task log acquisition unit 604 is further configured to: acquire, through sensors corresponding to the industrial device, a task log including operation information of the industrial device in the process of performing the industrial task.

In some examples, the apparatus 600 further comprises a reactivation unit configured to: determine whether the industrial device has finished the workflow after acquiring the task log of the industrial device; and reactivate the industrial device in response to the industrial device not finishing the workflow.

In some examples, the task parameters of the industrial device comprise a target torque and a target number of tightenings, the task log comprises an actual torque and an actual number of tightenings of the industrial device, and the apparatus 600 comprises: determining that the task completion condition of the industrial device is unqualified in response to a mismatch between the target torque and the actual torque and/or a mismatch between the target number of tightenings and the actual number of tightenings; and/or wherein the set task parameters of the industrial device include the number of parts scheduled to be used to perform the task and the task log includes the number of parts actually used during the performance of the task, and determining that the task completion condition of the industrial device is unqualified comprises: determining that the task completion condition of the industrial device is unqualified in response to a mismatch between the number of parts scheduled for use and the number of parts actually used; and/or wherein the set task parameters of the industrial device comprise the task steps scheduled for execution, the task log comprises the task steps actually executed during the execution of the task, and determining that the task completion condition of the industrial device is unqualified comprises: determining that the task completion condition of the industrial device is unqualified in response to the scheduled task steps not matching the actually executed task steps.

In some examples, the apparatus 600 comprises: determining that the task completion condition of the industrial device is unqualified in response to a mismatch between the target torque and the actual torque, and the apparatus 600 further comprises a calibration unit configured to: calibrate the torque of the industrial device based on the actual torque.

It will be understood that the apparatus 600 of the present disclosure may achieve at least one of a number of advantages that the method or process described above can achieve.

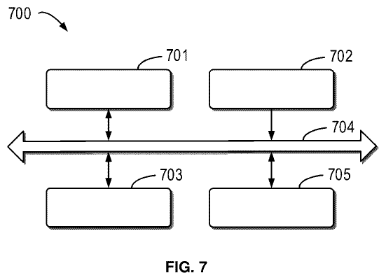

FIG. 7 shows a schematic block diagram of an example apparatus 700 that can be used to implement examples of the present disclosure. As shown in FIG. 7, the appliance 700 comprises a processor 701, which can perform various appropriate actions and processes according to computer program instructions stored in a read only memory (ROM) 702 and loaded into a random access memory (RAM) 703.

Various programs and data required for the operation of the device 700 may also be stored in the RAM 703. The processor 701, the ROM 702, and the RAM 703 are interconnected through a bus 704. An input/output (I/O) interface 705 is also connected to the bus 704.

The various processes and processing described above, such as the method 200, may be executed by the processor 701. For example, in some examples, the method 300 can be implemented as a computer software program tangibly contained in a machine-readable medium. In some examples, a part or all of the computer programs may be loaded and/or installed onto the apparatus 700 via the ROM 702. When the computer program is loaded onto the RAM 703 and executed by the processor 701, one or more actions of the method 300 described above may be performed.

The present disclosure may be a method, apparatus, system, and/or computer program product. The computer program product may comprise a computer-readable storage medium uploaded with computer-readable program instructions for performing various aspects of the present disclosure.

The computer-readable storage medium may be a tangible device that maintains and stores instructions used to instruct execution devices. The computer-readable storage medium, for example, may be—but is not limited to—an electrical storage device, magnetic storage device, optical storage device, electromagnetic storage device, semiconductor memory device, or any suitable combination of the above. More specific examples of the computer-readable storage medium (a non-exhaustive list) comprise: random access memory (RAM), read-only memory (ROM), erasable programmable read-only memory (EPROM or flash memory), static random access memory (SRAM), and any suitable combination of the above. The computer-readable storage medium used herein is not to be construed as transient signals per se, such as radio waves or other freely propagating electromagnetic waves, electromagnetic waves propagating through waveguides or other transmission media (e.g., light pulses through fiber optic cables), or electrical signals transmitted through wires.

The computer-readable program instructions described herein may be downloaded to various computing/processing devices from computer-readable storage medium, or downloaded from networks, such as the Internet, a local area network, a wide-area network and/or a wireless network to external computers or external storage devices. The networks may comprise copper transmission cables, optical fiber transmissions, wireless transmissions, routers, firewalls, switches, gateway computers, and/or edge servers. The network adapter card or network interface in each computing/processing device receives the computer-readable program instructions from the network and forwards the computer-readable program instructions for storage in computer-readable storage medium of each computing/processing device.

The computer program instructions used to execute the operations of the present disclosure may be assembly instructions, instructions set architecture (ISA) instructions, machine instructions, machine-related instructions, microcode, firmware instructions, state-setting data, or source code or object code written with any combination of one or many programming languages, with the programming languages including object-oriented programming languages such as Smalltalk, C++, etc., as well as conventional procedural programming languages such as “C” language or similar programming languages. Computer-readable program instructions may be fully executed on the user's computer, partially executed on the user's computer, executed as an independent software package, partially executed on the user's computer and partially executed on a remote computer, or fully executed on a remote computer or server. In the case of remote computers, the remote computer can be connected to the user's computer through any type of network—such as a local area network (LAN) or a wide area network (WAN)—or can be connected to an external computer (for example, through the Internet using an Internet Service Provider). In some examples, the state information of computer-readable program instructions is used to personalize custom electronic circuits, such as a programmable logic circuit, field-programmable gate array (FPGA) or programmable logic array (PLA), wherein the electronic circuit is able to execute computer-readable program instructions, thereby achieving the various aspects of the present disclosure.

Various aspects of the present disclosure are described herein with reference to flow charts and/or block diagrams depicting methods, apparatus (systems), and computer program products according to the examples of the present disclosure. It should be understood that every block in the flow charts and/or block diagrams and the combinations of various blocks in the flow charts and/or block diagrams may be implemented by computer-readable program instructions.

These computer-readable program instructions may be provided to general-purpose computers, dedicated computers or the processing units of other programmable data processing apparatuses, thereby producing a type of machine, such that when these instructions are executed by the computers or processing units of other programmable data processing apparatuses, an apparatus that realizes the functions/actions stipulated in one or more boxes in the flow charts and/or block diagrams is produced. These computer-readable program instructions may also be stored in computer-readable storage medium, enabling computers, programmable data processing apparatuses, and/or other devices to operate in a specific manner. Therefore, the computer-readable media containing instructions comprise a manufactured product that comprises instructions for implementing various aspects of the functions/actions specified in one or more boxes in the flow charts and/or block diagrams.

The computer-readable program instructions may also be loaded onto a computer, other programmable data processing apparatuses, or other devices, enabling a series of operational steps to be executed on the computer, other programmable data processing apparatuses, or other devices to generate a computer-implemented process. This enables the instructions executed on the computer, other programmable data processing apparatuses, or other devices to implement the functions/actions specified in one or more boxes in the flow charts and/or block diagrams.

The flow charts and block diagrams in the accompanying drawings show the system architecture, functions and operations that may be implemented based on the systems, methods and computer program products according to the plurality of examples of the present disclosure. Regarding this, every block in the flow chart or block diagram can represent a part of a module, program section or instructions, wherein the part of the module, program section or instructions contains one or a plurality of executable instructions that are used to implement the stipulated logic function. In some alternative implementations, the occurrence of the function indicated in the blocks may also differ from the sequence indicated in the accompanying drawings. For example, two continuous blocks may actually be substantially performed in a concurrent manner and they may also sometimes be performed in reverse order, depending on the functions involved. It must also be noted that every block in the block diagrams and/or flow charts, as well as combinations of blocks in the block diagrams and/or flow charts may be implemented by dedicated hardware-based systems used to perform the stipulated functions or actions, or implemented by using combinations of dedicated hardware and computer instructions.

The various examples of the present disclosure have been described above. The descriptions provided are exemplary and not exhaustive, and they are also not limited to the disclosed examples. Many modifications and variations will be apparent to those skilled in the art without departing from the scope and spirit of the described examples. The selection of terms used herein aims to best explain the principles and actual applications of various examples as well as the technological improvements in the technology in the market, or allow others of ordinary skill in the art to understand various examples disclosed herein.

What is claimed is:

1. A method for determining task status of an industrial device, comprising:
determining the task completion status of the industrial device;
in response to determining that the industrial device is in the task completed status, acquiring the task log of the industrial device, wherein the task log includes the operational information of the industrial device in the process of performing the assigned task; and
determining the completion condition of the task of the industrial device based on the task log and the set task parameters corresponding to the task assigned to the industrial device.

2. The method according to claim 1, wherein communication between the industrial device and the clamping device corresponding to the industrial device is short-range communication, and determining the task completion status of the industrial device comprises:
determining the task completion status of the industrial device based on the communication status of the short-range communication.

3. The method according to claim 2, wherein determining the task completion status of the industrial device based on the communication status of the short-range communication comprises:
determining a first time in response to the communication status of the short-range communication being the disconnected status;
determining a second time in response to the communication status of the short-range communication being the reconnected status; and
determining that the industrial device is in the task completed status in response to the time interval between the first time and the second time being greater than a predetermined time interval.

4. The method according to claim 2, wherein the clamping device is communicatively connected to the terminal device via a gateway, and the method further comprises determining task parameters corresponding to the task assigned to the industrial device, comprising:
determining task configuration information by the terminal device based on information entered by a user, wherein the task configuration information comprises a plurality of tasks and a plurality of corresponding task parameters; and
determining task parameters corresponding to the tasks assigned to the industrial device by assigning a plurality of tasks to a plurality of industrial devices based on the identification information of the industrial devices.

5. The method according to claim 4, wherein each of the plurality of tasks has configuration identification information, and determining the task parameters corresponding to the task assigned to the industrial device comprises:
determining the task assigned to the industrial device and the corresponding task parameters based on the matching result between the identification information of the industrial device and the configuration identification information of each task.

6. The method according to claim 5, further comprising:
activating and configuring the industrial device based on matching the configuration identification information with the identification information of the industrial device.

7. The method according to claim 1, wherein determining the completion condition of the task of the industrial device comprises:
determining that the task completion condition of the industrial device is unqualified and returning an abnormal notification when the set task parameters do not match the actual task parameters included in the task log.

8. The method according to claim 7, further comprising:
acquiring the working status of the industrial device when it is determined that the task completion condition of the industrial device is unqualified; and
adjusting the set task parameters of the industrial device based on the actual task parameters when the working status meets the preset requirements.

9. The method according to claim 1, wherein acquiring the task log of the industrial device comprises:
acquiring, through sensors corresponding to the industrial device, a task log including operation information of the industrial device in the process of performing the assigned task.

10. The method according to claim 6, wherein determining the completion condition of the task of the industrial device comprises:
determining whether the industrial device has finished the task flow based on whether the task flow in the task log matches the task flow in the set task parameters corresponding to the task assigned to the industrial device after acquiring the task log of the industrial device; and
determining that the completion condition of the task of the industrial device is incomplete and reactivating the industrial device in response to the industrial device not completing the task flow.

11. The method according to claim 7, wherein the set task parameters of the industrial device include the target torque and the target number of tightenings, the task log includes the actual torque and the actual number of tightenings of the industrial device, and determining that the task completion condition of the industrial device is unqualified comprises:
determining that the task completion condition of the industrial device is unqualified in response to a mismatch between the target torque and the actual torque and/or a mismatch between the target number of tightenings and the actual number of tightenings; and/or
wherein the set task parameters of the industrial device include the number of parts scheduled to be used to perform the task and the task log includes the number of parts actually used during the performance of the task, and determining that the task completion condition of the industrial device is unqualified comprises:
determining that the task completion condition of the industrial device is unqualified in response to a mismatch between the number of parts scheduled for use and the number of parts actually used; and/or
wherein the set task parameters of the industrial device comprise the task steps scheduled for execution, the task log comprises the task steps actually executed during the execution of the task, and determining that the task completion condition of the industrial device is unqualified comprises:
determining that the task completion condition of the industrial device is unqualified in response to the scheduled task steps not matching the actually executed task steps.

12. The method according to claim 11, wherein in response to a mismatch between the target torque and the actual torque, it is determined that the task completion condition of the industrial device is unqualified, the method further comprising:
calibrating the torque of the industrial device based on the actual torque.

13. An apparatus for determining task status of an industrial device, comprising:
a completion status determination unit configured to determine the task completion state of the industrial device;
a task log acquisition unit configured to acquire the task log of the industrial device in response to determining that the industrial device is in the task completed status, wherein the task log includes the operational information of the industrial device in the process of performing the assigned task; and
a completion determination unit configured to determine the completion condition of the task of the industrial device based on the task log and the set task parameters corresponding to the task assigned to the industrial device.

14. A controller, comprising:
at least one processor; and
a memory coupled to the at least one processor and having instructions stored thereon, the instructions, when executed by the at least one processor, causing the controller to perform the method according to claim 1.

15. A computer program product, the computer program product being tangibly stored on a non-volatile computer-readable medium and comprising machine-executable instructions, the machine-executable instructions, when executed, causing a machine to execute steps of the method according to claim 1.
